(19) United States
(12) Patent Application Publication
(10) Pub. No.: US 2025/0198708 A1
(43) Pub. Date: Jun. 19, 2025

(54) HEAT CONVERSION SYSTEM AND HEAT CONVERSION METHOD

(71) Applicant: NIPPON TELEGRAPH AND TELEPHONE CORPORATION, Tokyo (JP)

(72) Inventors: Hidenobu HIROTA, Musashino-shi, Tokyo (JP); Kazutaka NOTO, Musashino-shi, Tokyo (JP); Takui UEMATSU, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/847,890

(22) PCT Filed: Apr. 8, 2022
(86) PCT No.: PCT/JP2022/017363

§ 371 Date: Sep. 17, 2024

(51) Int. Cl. F28D 21/00; B63B 35/44

(52) U.S. Cl. CPC F28D 21/00; B63B 2035/4453; F28D 2021/0019

(57) ABSTRACT

An object of the present disclosure is to lower a temperature in the vicinity of a water surface.

According to the present disclosure, a thermal conversion system includes a float 20 floating on water and a thermal conversion unit 10 connected to the float 20 and configured to connect the vicinity of a water surface and a predetermined water depth by a medium that has thermal conductivity. The vicinity of the water surface is cooled by transmitting heat in the vicinity of the water surface to the predetermined water depth.

### TECHNICAL FIELD

The present disclosure relates to a system and a method of lowering a temperature in the vicinity of a water surface.

### BACKGROUND ART

Warming in which an atmospheric temperature of the Earth rises is a threat to human beings. An increase in temperature is caused by an increase in concentration of greenhouse gases in the atmosphere. Greenhouse gases are presented in the atmosphere and have the characteristic of observed some of the infrared rays emitted from the ground surface. Without greenhouse gases, infrared rays would pass through the atmosphere, but infrared rays remain in the atmosphere due to greenhouse gases, which causes changes in the atmosphere. As a result, in almost the whole world, an average temperature is higher than in the past. In the period of 1880 to 2012, the average temperature rose by about 0.9 degrees.

The best known effect of global warming is a rise in temperature and the sea level. When the sea surface rises, adverse effects such expansion in coastal erosion, a loss of land and property, migration of people, an increase in risk of storm surges, weakening natural coastal ecosystems, and intrusion of seawater into fresh water resources occur.

Photovoltaic power generation is a typical example of efforts to reduce amounts of greenhouse gases. Photovoltaic power generation is a system that directly converts sunlight into electric power. Since fuel is not required for power generation itself, no greenhouse gases are emitted. Therefore, solar panels have been installed all over Japan as a national strategy. In particular, the amount of installation has increased since 2012. However, the atmospheric temperature of the Earth has not been reported as having lowered, but rather has increased.

That is, current countermeasures including solar power generation are insufficient, and further countermeasures are necessary (see, for example, Non Patent Literature 1). Here, the IPCC, which is an abbreviation for the United Nations Intergovernmental Panel Climate Change (Intergovernmental Panel on Climate Change), is an organization established for the purpose of comprehensively evaluating anthropogenic climate change, influences, adaptation and mitigation measures from a scientific, technical and socio-economic viewpoints.

### CITATION LIST

### Non Patent Literature

Non Patent Literature 1: IPCC dai 5-ji hyoka hokokusho tokusetsu page (Nihongo) (in Japanese) (Special page (in Japanese) of Fifth Assessment Report of the IPCC) https://www.jccca.org/ipcc/ar5/wg1.html

### SUMMARY OF INVENTION

### Technical Problem

The inventors and others have studied means for lowering the atmospheric temperature of the Earth rather than a technique for reducing the emissions of the greenhouse gases, and have focused on the seawater that covers the Earth. FIG. 1 illustrates water depths and water temperatures in the sea. Although the names of the surface mixed layer and the like change, the water temperature decreases as the water depth becomes deeper. The water temperature falls below 5 degrees when the water depth exceeds 4000 meters. That is, it is found out that seawater itself is cold. The seawater is in contact with the atmosphere. If the temperature in the vicinity of the sea surface can be lowered, the atmospheric temperature in contact with the seawater is lowered.

Accordingly, an object of the present disclosure is to lower the temperature in the vicinity of the water surface.

### Solution to Problem

The inventors have studied a method of cooling the atmosphere using cold energy in the seawater. For example, when seawater is agitated and energy is extracted, energy for agitation is required. In this case, more greenhouse gases would be emitted in order to produce the energy, which would be illogical Therefore, the inventors have devised a system that lowers the temperature in the vicinity of the sea surface without uselessly wasting energy such as agitation.

Specifically, according to an aspect of the present disclosure, the thermal conversion system includes: a float floating on water; and a thermal conversion unit connected to the float and configured to connect the vicinity of a water surface and a predetermined water depth by a medium that has thermal conductivity.

Specifically, according to another aspect of the present disclosure, a thermal conversion method includes cooling the vicinity of the water surface by a thermal conversion unit that has thermal conductivity by transmitting heat in the vicinity of the water surface to a predetermined water depth.

The thermal conversion unit may include a metal plate disposed in the vicinity of the water surface and a metal wire extending from the metal plate in a water depth direction.

Here, the cross-sectional shape of the metal wire may be polygonal.

The thermal conversion system according to the aspect of the present disclosure may include: an optical fiber configured to sense a temperature in water; and a temperature measurement device configured to measure a temperature sensed by the optical fiber.

The thermal conversion system according to the aspect of the present disclosure may include: a position measurement device configured to measure a geographical position of the float; and a propulsion unit configured to move the float to a predetermined geographical position based on the geographical position measured by the position measurement device.

In this case, the thermal conversion system according to the aspect of the present disclosure may include: a solar panel configured to convert solar energy into electric power; and a battery configured to supply the electric power generated by the solar panel to the position measurement device and the propulsion unit.

The aspects of the disclosures described can be combined as far as possible.

### Advantageous Effects of Invention

According to the present disclosure, the temperature in the vicinity of the water surface can be lowered. Therefore, the atmospheric temperature in contact with the water surface can be lowered by applying the present disclosure to any water surface on the Earth such as the sea.

### BRIEF DESCRIPTION OF DRAWINGS

FIG. 1 is a diagram illustrating a correlation between a water depth and a water temperature in the sea.

FIG. 2 is a diagram illustrating an example of a structure of a thermal conversion system.

FIG. 3 is a diagram illustrating an example of a cross-sectional structure of a metal wire.

FIG. 4 is a diagram illustrating an example of laying a thermal conversion system in the sea and energy transfer.

FIG. 5 is a diagram illustrating an example of a temperature change of the atmosphere accompanying seawater cooling.

FIG. 6 is a diagram illustrating an example of a structure of the thermal conversion system that has a function of allowing observation of seawater temperature.

FIG. 7 is a diagram illustrating an example of a structure of a thermal conversion system having power supply and position correction functions.

FIG. 8 is a diagram illustrating a connection example of the thermal conversion system.

### DESCRIPTION OF EMBODIMENTS

Hereinafter, embodiments of the present disclosure will be described in detail with reference to the drawings. The present disclosure is not limited to the embodiments to be described below. These embodiments are merely exemplary, and the present disclosure can be implemented in forms of various modifications and improvements based on the knowledge of those skilled in the art. Constituents having the same reference signs in the present specification and the drawings are the same constituents.

### First Embodiment

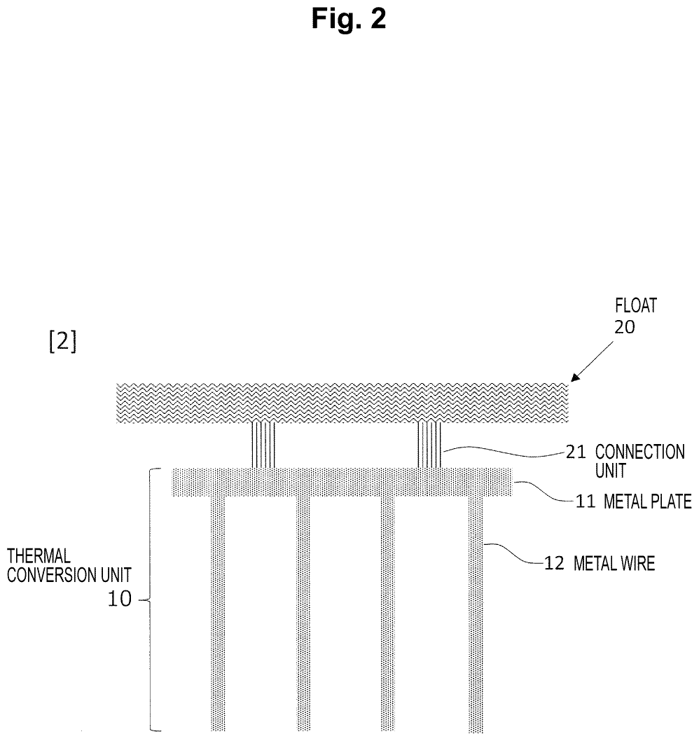

In the embodiment, a structure of a devised thermal conversion system will be described. An example of the structure of the system is illustrated in FIG. 2. The present disclosure includes three structures. First, a thermal conversion unit 10 includes a metal plate 11 and a metal wire 12, and these portions have a thermal conversion function. The second is a float 20, which is a function necessary for floating this system on the sea.

Although the shape of the float 20 is arbitrary, may be, for example, a flat plate. A material of the float 20 may be any material that floats on water, and is, for example, polyurethane. The metal plate 11 and the metal wire 12 are any medium that has thermal conductivity. For example, a metal material can be used. The metal plate 11 and the metal wire 12 are preferably made of a material that has high thermal conductivity. The material may be, for example, copper which is a metal material having a stable price and which is readily available.

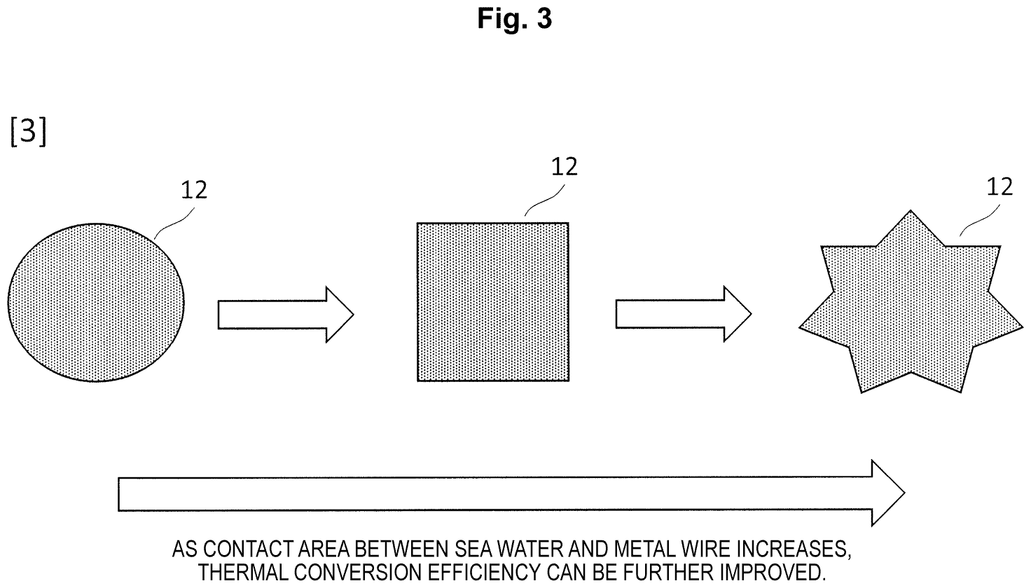

The shape of the metal wire 12 will also be described. With regard to causing seawater to absorb heat of the metal wire 12, this is more effective as a contact area between the seawater and the metal wire 12 becomes larger. FIG. 3 illustrates an example of a cross-sectional shape of the metal wire 12. The cross-sectional shape of the metal wire 12 is generally a circle. Since it is easy to make a circle, a circle is the most readily available. However, by forming the cross-sectional shape of the metal wire 12 into a polygonal shape such as a square or a star shape, the thermal conversion efficiency can be further improved.

The third is a connection unit 21 connecting the thermal conversion unit 10 and the float 20. As the structure of the connection unit 21, for example, a shape of a hook that is used to connect a train to a train and is less likely to be disconnected can be used.

In FIG. 2, an example in which four metal wires 12 are connected to one metal plate 11 is illustrated, but the present disclosure is not limited thereto. For example, the number of metal wires 12 connected to the metal plate 11 may be 3 or less or may be 5 or more. Each metal wire 12 is not limited to one wire, and may be a wire rope in which a plurality of wires have been gathered together. Accordingly, since the wire can bend flexibly curved in accordance with sea currents, an influence on the sea current can be reduced.

### Second Embodiment

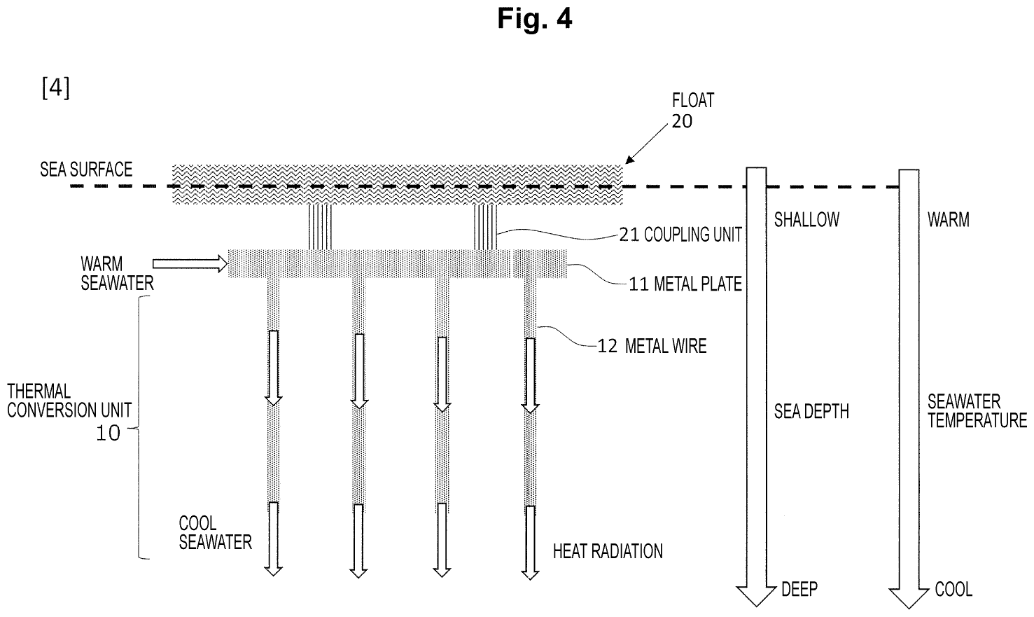

In a second embodiment, a method of using the system of the first embodiment will be described. FIG. 4 illustrates an example of laying the thermal conversion system devised in the sea. Since the float 20 is provided, the unit is installed on the sea surface. Since the float 20 and the thermal conversion unit 10 are connected, the metal plate 11 and the metal wire 12 are installed in the sea. In the system, the metal plates 11 are installed in the depth direction in the sea.

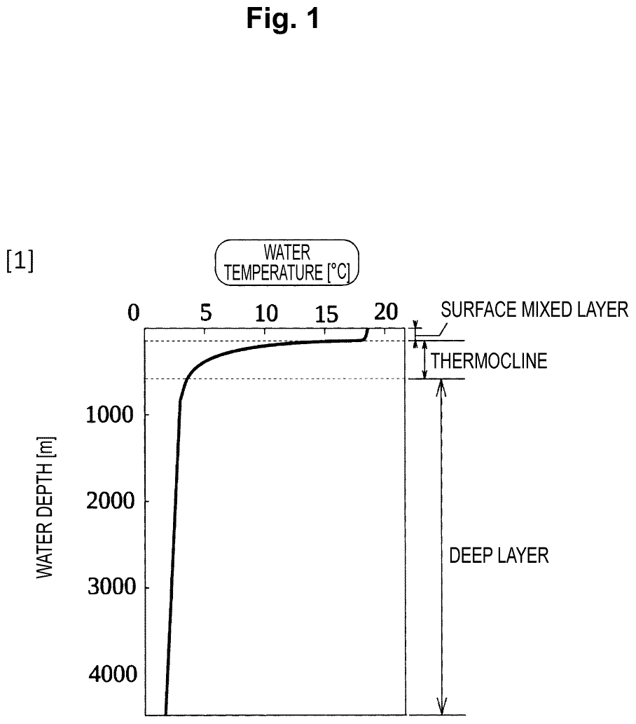

The metal wire 12 extending from the metal plate 11 extends in the depth direction in the sea. As illustrated in FIG. 1, the temperature of the seawater is lower, that is, becomes cooler, as seawater becomes deeper. That is, energy moves through the metal plate 11 and the metal wires 12. Warm energy in the vicinity of the sea surface propagates through the metal wires 12 to cold energy areas which are deep in the sea. That is, the seawater temperature in the vicinity of the sea surface is lowered to reach a cooling temperature.

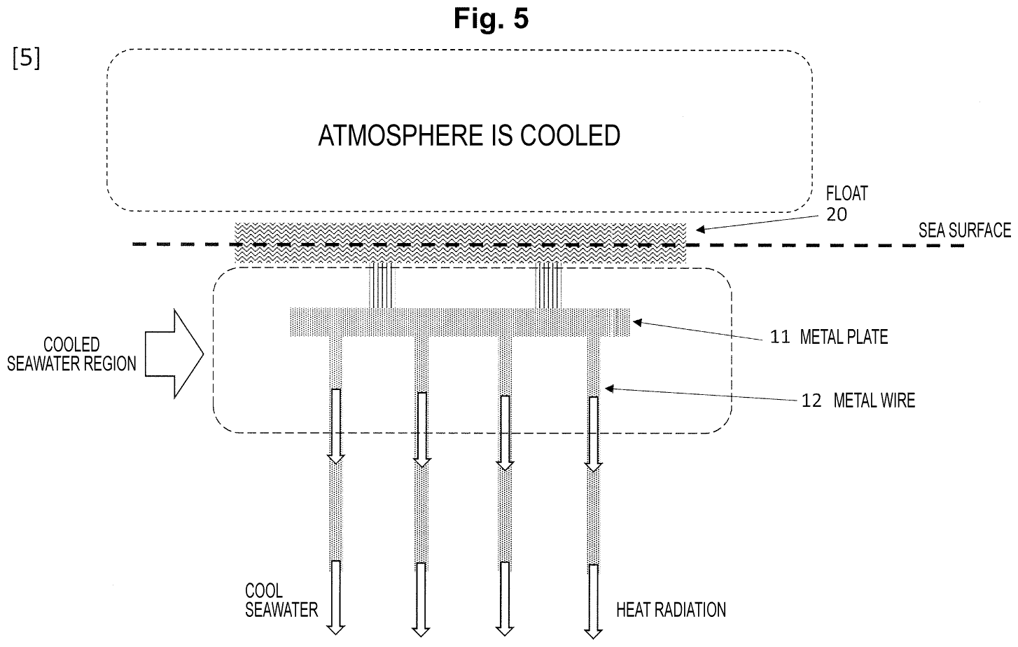

FIG. 5 illustrates cooling of the atmosphere. When the temperature of the seawater surface is lowered by the devised thermal conversion system, the air in contact with the seawater surface is also cooled. In order to lower the temperature of the seawater surface, cold energy deep in the seawater can be used to cool the atmosphere.

The metal plate 11 may be disposed in the vicinity of the sea surface. The vicinity of the sea surface may be in the water or above the water. When the vicinity of the sea surface is in the water, the temperature is preferably close to the atmospheric temperature. For example, the metal plate 11 is disposed at a water depth of 0 meters or more and 30 meters or less. The tip of the metal wire 12 may be disposed at any water depth at which the temperature of the metal plate 11 can be lowered. For example, the tip of the metal wire 12 can be disposed at a water depth of 50 meters or more.

### Third Embodiment

In a third embodiment, an example in which a function of observing a change in seawater temperature is installed in the thermal conversion system of the embodiment will be described. In the system, in order to cool the atmosphere, a change in temperature of the seawater occurs. Accordingly, the system according to the embodiment has the function of observing a change in temperature of seawater.

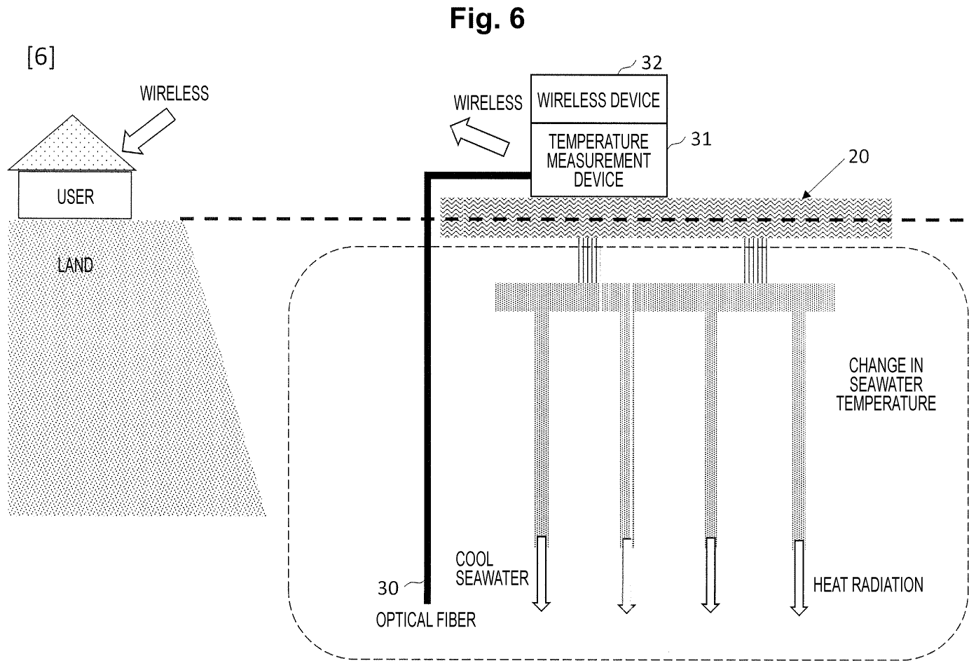

FIG. 6 illustrates an observation method. For observation, an optical fiber thermometer is used. An optical fiber 30 is installed in the depth direction, and a temperature measurement device 31 is disposed on one side of the optical fiber 30. One of the characteristics of the optical fiber 30 is that the optical fiber 30 itself also contracts in the longitudinal direction when the temperature of the optical fiber is changed due to a change in an ambient temperature. A change in the optical fiber 30 is referred to as a strain. This strain can be evaluated by the temperature measurement device 31 installed on one side of the optical fiber 30. An amount of change in the seawater temperature can be estimated at each depth using a distribution of the strain amount in the length direction of the optical fiber 30. Accordingly, the thermal conversion system according to the embodiment can ascertain the amount of change in the seawater temperature caused due to the installation of the thermal conversion system. The temperature measurement device 31 includes a wireless device 32 and can wirelessly transmit measured data to a user.

### Fourth Embodiment

In a fourth embodiment, an example in which a position correction function is mounting on the thermal conversion system according to the embodiment will be described. The heat exchange system is provided with a float 20 and is installed at sea. There is a current of the sea, and an article floating on the sea moves by the flow of the current of the sea. Even if there is an area where the atmosphere is desired to be cooled, there is a possibility of the system flowing to another area. Accordingly, the thermal conversion system according to the embodiment has a configuration for preventing the air from flowing from the area where the air is desired to be cooled.

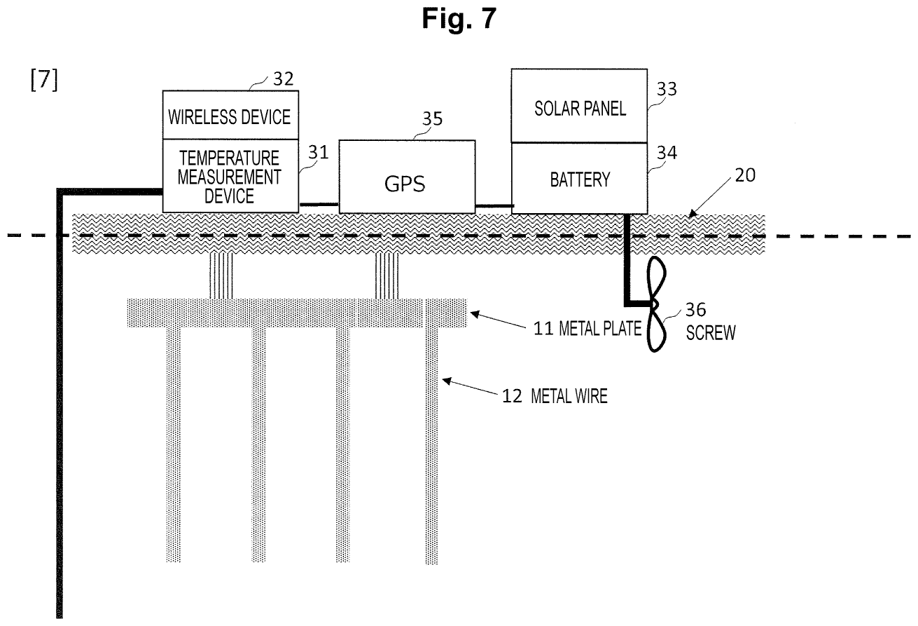

FIG. 7 illustrates a configuration example of the system according to the embodiment. The thermal conversion system according to the embodiment includes a Global Positioning System (GPS) 35 that functions as a position measurement device, a screw 36 functioning as a propulsion unit, a solar panel 33, and a battery 34.

The solar panel 33 that converts solar energy into electric power is installed on the surface of the float 20 so that the solar panel 33 generates electric power. The battery 34 that stores the electric power is disposed. Power is distributed from the battery 34 to the temperature measurement device 31, the wireless device 32, the GPS 35, and the screw 36.

The GPS 35 measures a geographical location of float 20. Since the thermal conversion system according to the embodiment includes the GPS 35, it is possible to accurately ascertain the geographical position. Therefore, for example, when the thermal conversion system moves due to an influence of a sea current and deviates from a predetermined geographical position, the thermal conversion system according to the embodiment can activate the screw 36 to move the float 20 to the predetermined geographical position. Power is required for the temperature measurement device 31 to measure a strain of the optical fiber 30 and for the wireless device 32 to wirelessly transmit data to the land, but this can be implemented with the power of the battery 34.

### Fifth Embodiment

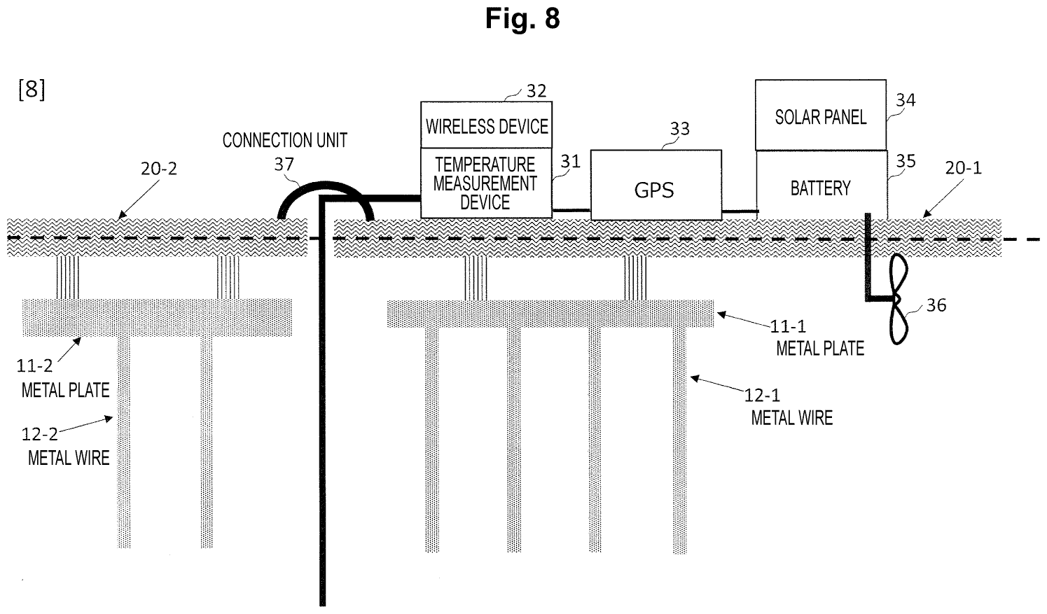

FIG. 8 illustrates a connection example of a plurality of thermal conversion systems. In the present disclosure, a thermal conversion system is constructed in the seawater by the float 20 or the like. According to the present disclosure, it is possible to facilitate an increase in an area where the atmospheric temperature is lowered by connecting the floats 20. As the structure of the connection unit 37, for example, it is possible to use a hook shape that is hardly disconnected, the hook shape being used when a train is connected a train, like the connection unit 21. Various devices which are mounted on the float 20 can also be changed as necessary.

In the above-described embodiment, an example in which the water surface is the sea surface has been described, but the present disclosure is not limited thereto. As long as the temperature of a water surface decreases according to the water depth, as illustrated in FIG. 1, the atmospheric temperature can be lowered by disposing the thermal conversion system according to the present disclosure in the vicinity of any water surface on the Earth such as a lake.

### REFERENCE SIGNS LIST

11 Metal plate
12 Metal wire
20 Float
21, 37 Connection unit
30 Optical fiber
31 Temperature measurement device
32 Wireless device
33 Solar panel
34 Battery
35 GPS
36 Screw

1. A thermal conversion system comprising:
a float floating on water; and
a thermal conversion unit connected to the float and configured to connect the vicinity of a water surface and a predetermined water depth by a medium that has thermal conductivity.

2. The thermal conversion system according to claim 1, wherein the thermal conversion unit includes a metal plate disposed in the vicinity of the water surface and a metal wire extending from the metal plate in a water depth direction.

3. The thermal conversion system according to claim 2, wherein a cross-sectional shape of the metal wire is polygonal.

4. The thermal conversion system according to claim 1, further comprising:
an optical fiber configured to sense a temperature in water; and
a temperature measurement device configured to measure a temperature sensed by the optical fiber.

5. The thermal conversion system according to claim 1, further comprising:
a position measurement device configured to measure a geographical position of the float; and
a propulsion unit configured to move the float to a predetermined geographical position based on the geographical position measured by the position measurement device.

6. The thermal conversion system according to claim 5, further comprising:
a solar panel configured to convert solar energy into electric power; and
a battery configured to supply the electric power generated by the solar panel to the position measurement device and the propulsion unit.

7. A thermal conversion method comprising:
cooling the vicinity of the water surface by a thermal conversion unit that has thermal conductivity by transmitting heat in the vicinity of the water surface to a predetermined water depth.
